(19) United States
(12) Patent Application Publication
(10) Pub. No.: US 2011/0087499 A1
(43) Pub. Date: Apr. 14, 2011

(54) DIALYSIS TREATMENT PLANNING AND COST OPTIMIZATION

(75) Inventors: Vivek Menon, Somerville, MA (US); Joshua Nelken, Westford, MA (US); Joseph Turk, North Andover, MA (US)

(73) Assignee: NxStage Medical, Inc., Lawrence, MA (US)

(21) Appl. No.: 12/903,171

(22) Filed: Oct. 12, 2010

Related U.S. Application Data
(60) Provisional application No. 61/251,202, filed on Oct. 13, 2009.

(51) Int. Cl. G06Q 50/00; G06Q 10/00

(52) U.S. Cl. 705/2

(57) ABSTRACT

A system, method and computer readable medium for dialysis treatment planning and optimization is disclosed. The system can include a processor programmed to perform operations including receiving a dialysis treatment parameter set and retrieving a predetermined list of dialyzers and corresponding cost and performance data for each dialyzer. The operations can also include iteratively calculating a cost impact of different treatment scenarios, the cost impact being determined based both on a clinical impact and on a cost value. Each scenario can be stored along with the dialysis treatment parameters and the calculated cost impact for each scenario. The operations can further include selecting the scenario having the most desirable cost impact; and outputting the selected scenario including the cost impact and the dialysis treatment parameters for the selected scenario.

This application claims the benefit of U.S. Provisional Application No. 61/251,202, entitled “Dialysis Treatment Planning and Cost Optimization,” filed on Oct. 13, 2009, which is incorporated herein by reference in its entirety.

Embodiments generally relate to dialysis treatment planning, and, in particular, to dialysis treatment planning and clinical/cost optimization.

Conventional kinetic calculators with varying degrees of sophistication are available in various formats such as web-based, PDA applications, and as PC software applications. However, conventional calculators may suffer from one or more limitations such as requiring manual input of individual patient data (or case information). Also, conventional systems may only consider clinical factors and may not optimize for both clinical factors and cost.

Embodiments of the present invention were conceived in light of the above limitations, among other things.

In general, embodiments of the disclosed system, method and computer readable medium/computer program product can include one or more of the following features:

a) ability to operate as an iterative program so as to calculate multiple scenarios (clinical and/or cost), save the results of each and display the best available scenario to a user;

b) ability to consider the cost and clinical impact of the different scenarios, whereas existing or conventional calculators may not consider cost optimization; and

c) ability to process multiple cases (patients) in an automated “bulk” input mode, whereas other calculators may only take inputs manually corresponding to one case (patient) at a time.

Embodiments can receive information about treatment requirements and a selection of different dialyzers and output the most cost-effective combination of medical components to reach target efficacy.

Embodiments can be used as a clinical tool for treatment planning/optimization and also as an illustrative marketing tool to help physicians/users determine the cost impact of changing common dialysis treatment inputs such as blood flow, dialysate flow, treatment time and dialyzer type and/or size to meet required patient adequacy targets. The impact of changing one or more of the above inputs is calculated with the use of commonly known dialysis kinetic equations, for example, as provided in “Handbook of Dialysis. 4th Edition”, J T Daugirdas, P G Blake, T S Ing; 2007 Lippincott Williams & Wilkins and on Medisystems Streamline blood flow engineering testing (TR1397). Cost impact is calculated based on cost inputs provided by the physician/user. Constraints for cost and kinetic inputs are options that can be modified by the physician/user and used in the calculation of cost impact and analysis of various scenarios.

One embodiment includes a method for automatically determining a cost impact of changing a dialysis treatment parameter. The method includes receiving, at a processor, a plurality of dialysis treatment parameter sets, each set corresponding to one of a plurality of patients and including one or more dialysis parameters, and retrieving, from an electronic data storage device, a predetermined list of dialyzers and corresponding cost and performance data for each respective dialyzer in the predetermined list of dialyzers. The method also includes iteratively calculating in the processor, for each patient, a cost impact of at least one scenario in which one or more of the dialysis treatment parameters in the dialysis treatment parameter set for that patient have been changed, the cost impact being determined based both on a clinical impact of changing the one or more dialysis treatment parameters and on a cost value of changing the one or more dialysis treatment parameters including changing a dialyzer for the scenario to one of the dialyzers selected from the predetermined list of dialyzers. Once the scenarios are calculated, the method includes storing each scenario, including the dialysis treatment parameters and the calculated cost impact for each scenario, in the electronic data storage device so as to make each cost impact calculation available for output by the processor. The scenario having the most desirable cost impact is selected for each patient. The method includes outputting each selected scenario including the cost impact and the dialysis treatment parameters for each selected scenario.

### BRIEF DESCRIPTION OF THE DRAWINGS

FIG. 1 shows an exemplary system for dialysis treatment planning and optimization in accordance with the present disclosure;

FIG. 2 shows an exemplary method for dialysis treatment planning and optimization in accordance with the present disclosure;

FIG. 3 shows an exemplary dialyzer list user interface for editing and updating a list of dialyzers to be used with the system or method of the present disclosure;

FIG. 4 shows an exemplary mode and options selection user interface screen for a dialysis treatment and planning software program in accordance with the present disclosure;

FIG. 5 shows an exemplary clinical options user interface screen for a dialysis treatment and planning software program in accordance with the present disclosure;

FIG. 6 shows an exemplary cost options user interface screen for a dialysis treatment and planning software program in accordance with the present disclosure;

FIG. 7 shows an exemplary advanced options user interface screen for a dialysis treatment and planning software program in accordance with the present disclosure;

FIG. 8 shows an exemplary dialysis clinical and cost optimization user interface screen in accordance with the present disclosure;

FIG. 9 shows an exemplary dialysis clinical and cost optimization user interface screen in accordance with the present disclosure with a result displayed;

FIG. 10 shows an exemplary output including multiple scenarios for clinical and cost optimization;

FIG. 11 shows an exemplary dialysis clinical and cost optimization system embedded within a dialysis machine; and

FIG. 12 shows an exemplary dialysis clinical and cost optimization system adapted to provide optimization information via a network.

### DETAILED DESCRIPTION

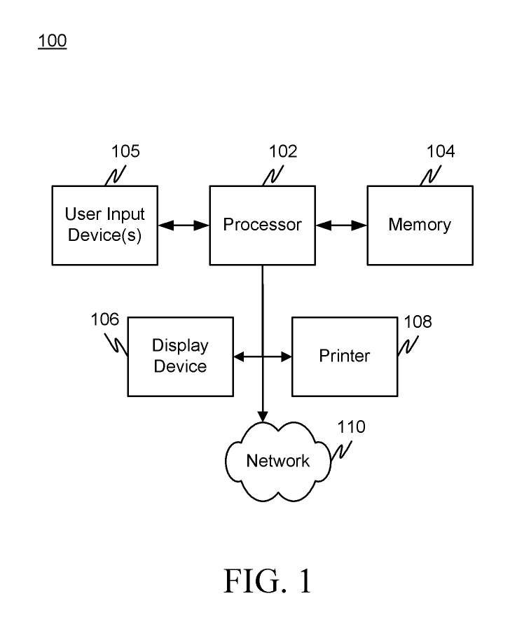

FIG. 1 shows an exemplary system for dialysis treatment planning and optimization in accordance with the present disclosure. In particular, a system 100 includes a processor 102 coupled to: a memory 104, one or more optional user input devices 105 (e.g., keyboard, mouse, and/or the like), an optional display device 106 (e.g., CRT, LCD, LED, plasma, or the like), an optional printer 108, and an optional wired and/or wireless network 110.

In operation, the memory 104 can store software instructions that, when executed by the processor 102, cause the processor to perform a dialysis treatment planning and optimization process in accordance with the present disclosure. The memory 104 can be a computer readable medium such as a semiconductor memory device (e.g., RAM, ROM, flash memory), an optical disc (CD, DVD, etc.), magnetic disc, or the like. Results of the optimization process can be output to the display device 106, the printer 108 or communicated over the network 110 to another system (not shown).

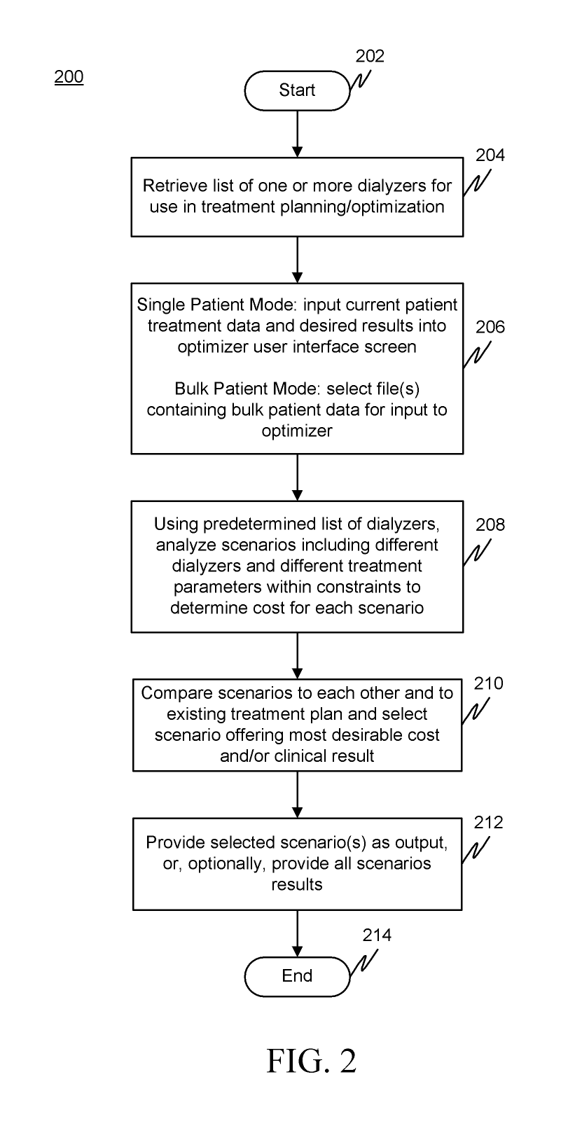

FIG. 2 shows an exemplary method for dialysis treatment planning and optimization in accordance with the present disclosure. In particular, a method 200 begins at 202 and processing continues to 204.

At 204, a list is obtained that contains information on one or more dialyzers to be used for treatment planning and optimization. The list can be retrieved from a local memory or database, or can be retrieved from a remote system. Processing continues to 206.

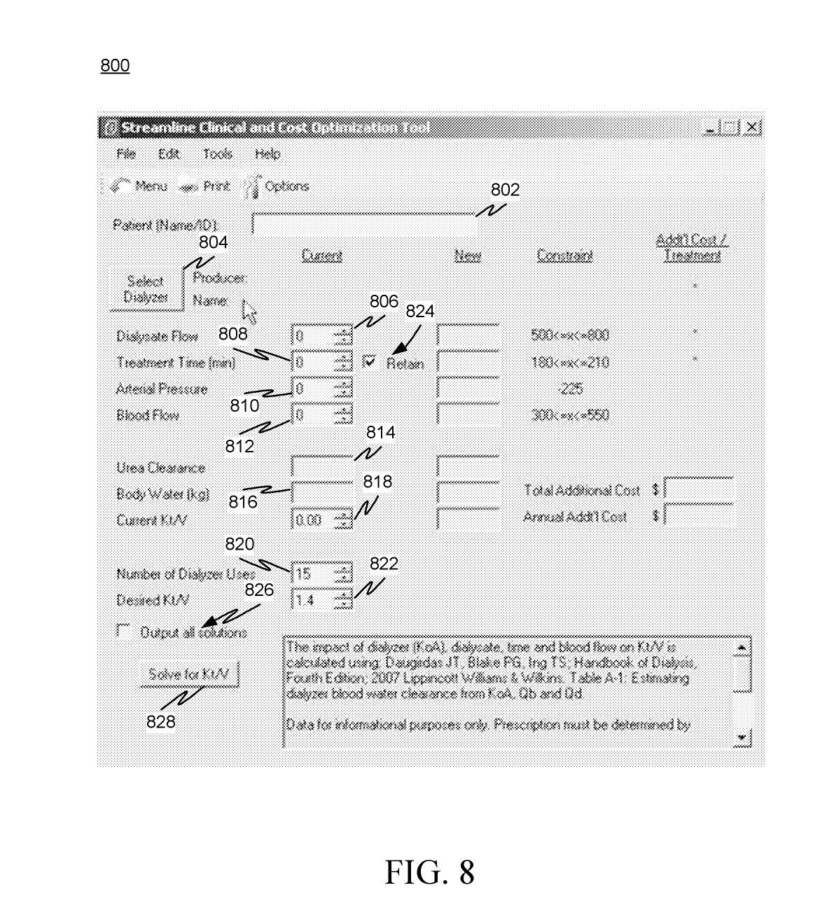

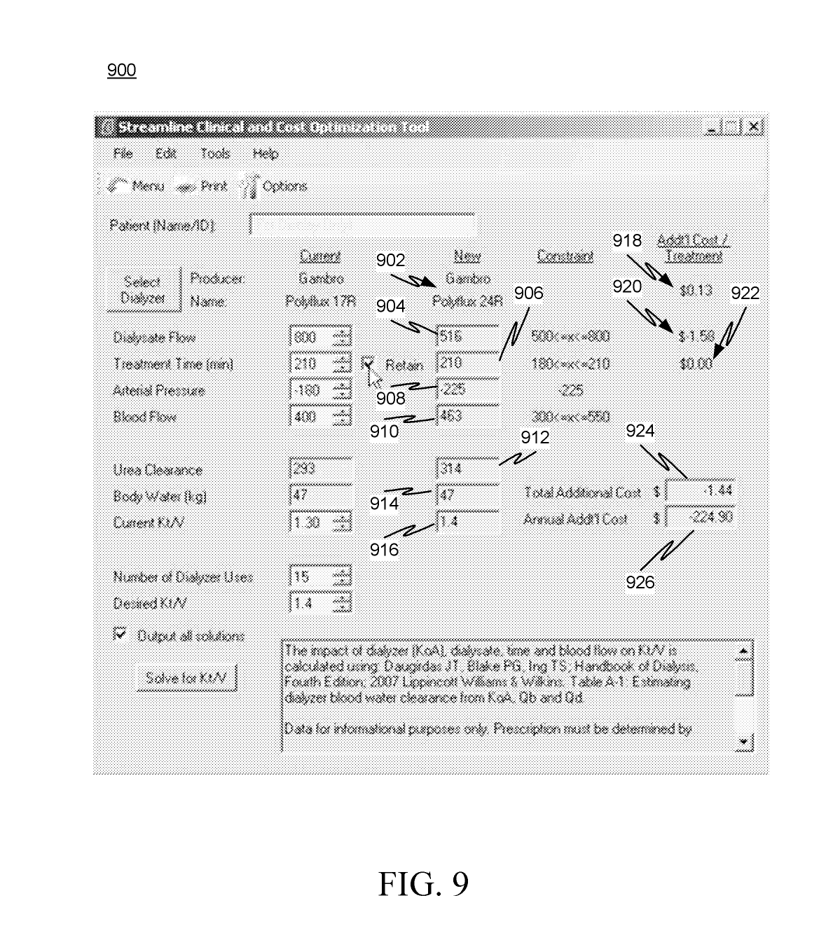

At 206, patient or case data in input according to a single patient mode or a bulk input mode selection. In single patient mode, the patient treatment data can be input using a user interface screen as shown in FIGS. 8 and 9 and described below. Alternatively, the single patient data can be input using any suitable means such as reading a file or receiving an electronic message containing the patient treatment information. In the bulk input mode, data for a plurality of patients is input at once using a method such as reading a data file or through other suitable means such as receiving a data stream or electronic message. Processing continues to 208.

At 208, input data, including the dialyzer list and patient treatment data, is processed and transformed into different treatment scenarios, which can be automatically analyzed to determine the clinical and/or cost impact of each scenario. For example, given a current treatment plan for a patient including the use of a current dialyzer, a number of alternative scenarios can be generated using other dialyzers that may meet clinical, time or cost constraints and may also provide a different cost than the current treatment. It may be determined that one of the other dialyzers or treatment plans may be able to achieve a same or similar clinical result for the patient and may also result is a cost savings (e.g., a savings of expendable items, a savings of time, or both). Processing continues to 210.

At 210, the generated scenarios are compared to each other and to the existing treatment plan to determine whether one or more of the scenarios may result in an improved treatment for the patient based on a clinical factor, a cost factor, or both. The scenario that produces the most desirable result either clinically, cost-wise, or both can be selected. Processing continues to 212.

At 212, each of the selected scenarios is provided as output. The output can be in the form of a video display, a print out, or an electronic communication to another system. Optionally, all of the calculated scenarios may be provided as output for a user or physician to evaluate. Processing continues to 214, where processing ends.

It will be appreciated that steps 202-214 can be repeated in whole or in part to accomplish a contemplated dialysis treatment planning and optimization task.

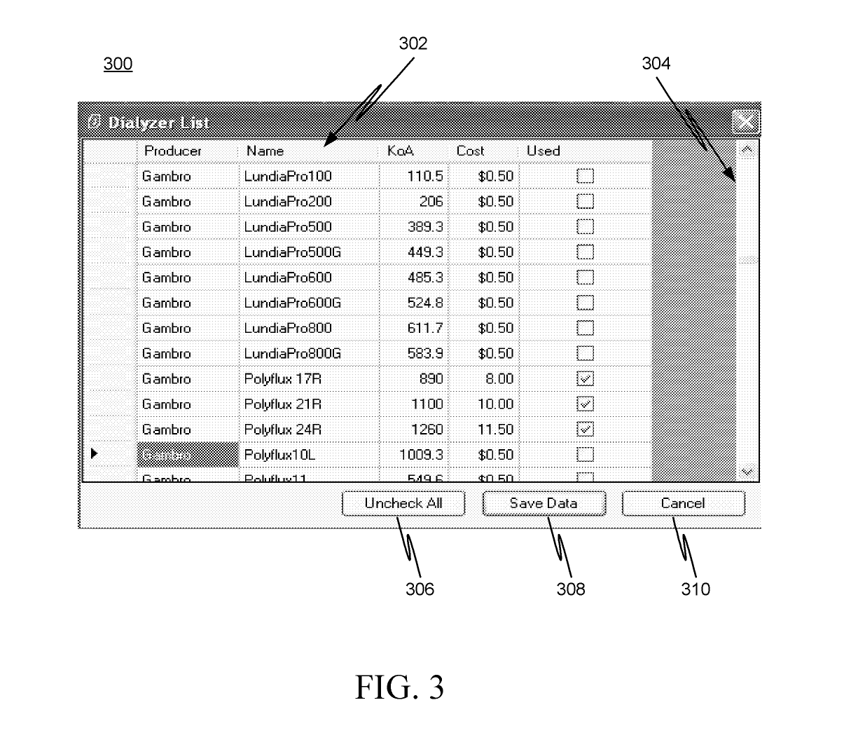

FIG. 3 shows an exemplary dialyzer list user interface for editing and updating a list of dialyzers to be used with the system or method of the present disclosure. In particular, a dialyzer list user interface screen 300 includes a list 302 including a dialyzer producer, a product name, a KoA value (dialyzer permeability coefficient), a cost value, and a checkbox indicating whether this dialyzer is used. The dialyzer list user interface also includes slider bar to scroll the list of dialyzers 304, an “uncheck all” button 306, a save data button 308 and a cancel button 310.

In operation, the dialyzer list user interface 300 can be used immediately after installation of the dialysis treatment planning and optimization software to configure the list of dialyzers to be used (by checking the corresponding checkboxes) and the cost values associated with each dialyzer (by editing the cost values). The dialyzer list user interface can also be used as needed to update and/or edit the dialyzers used and the cost values associated with each dialyzer.

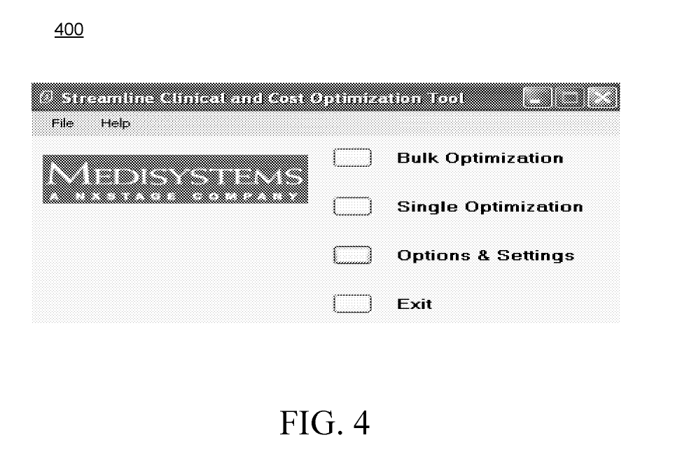

FIG. 4 shows an exemplary mode and options selection user interface screen for a dialysis treatment and planning software program in accordance with the present disclosure. In particular, the mode and options screen 400 includes buttons for selecting bulk optimization mode, single optimization, options and settings, and exit.

When bulk optimization mode is selected, the program processes multiple cases (patients) in an automated “bulk” input mode. Single optimization is used for optimizing the treatment for a single patient for which data can be input manually.

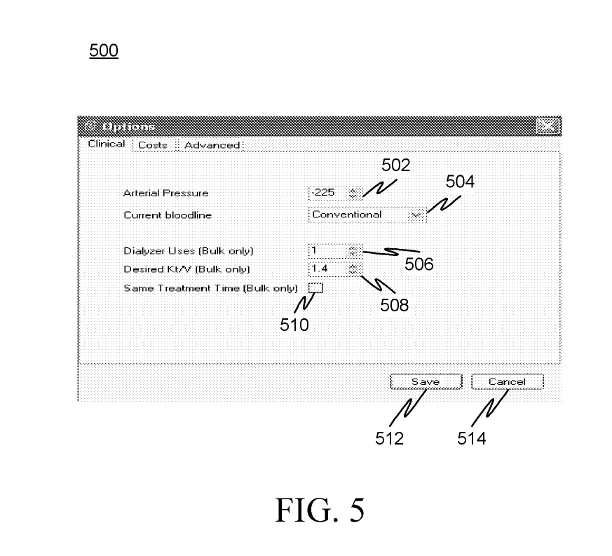

When the options and settings button is selected, the options user interface is displayed. The options user interface panels are shown in FIGS. 5-7 and described in detail below. When the exit button is selected, the program terminates.

FIG. 5 shows an exemplary clinical options user interface screen panel for a dialysis treatment and planning software program in accordance with the present disclosure. In particular, the clinical options panel 500 includes user interface elements for entering the following: arterial pressure 502, current bloodline 504, number of dialyzer uses 506 (for bulk mode), a desired Kt/V value 508 (for bulk mode), and a checkbox 510 for using the same treatment time in bulk mode. The options user interface screen includes a save button 512 and a cancel button 514 that can be common to all option panels.

Kt/V is a number that can be used to quantify hemodialysis and peritoneal dialysis treatment adequacy, where K is dialyzer clearance of urea, t is dialysis time, and V is a patient's total body water.

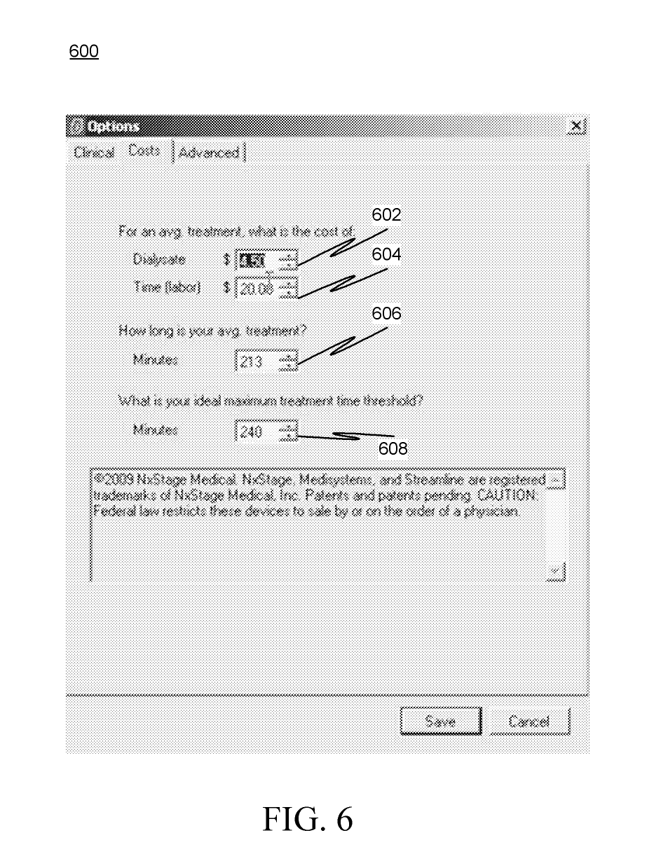

FIG. 6 shows an exemplary cost options user interface panel for a dialysis treatment and planning software program in accordance with the present disclosure. in particular, the cost options panel 600 includes user interface elements for displaying and editing the following: average dialysate cost 602, average labor (time) cost per treatment 604, length of time for average treatment 606, and ideal maximum treatment time threshold 608.

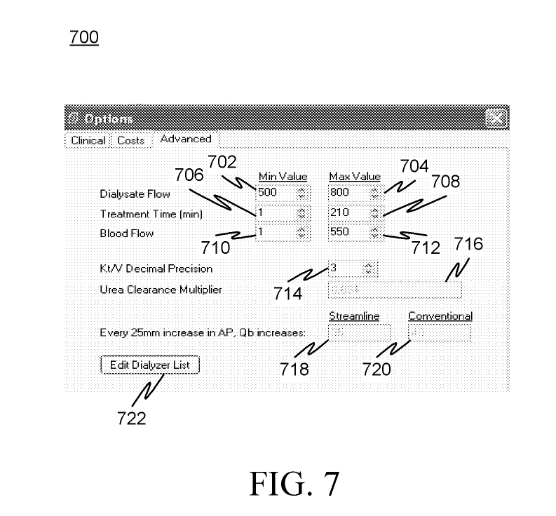

FIG. 7 shows an exemplary advanced options user interface panel for a dialysis treatment and planning software program in accordance with the present disclosure. The advanced options panel 700 includes user interface elements for displaying and/or editing the following: minimum dialysate flow value 702, maximum dialysate flow value 704, minimum treatment time 706, maximum treatment time 708, minimum blood flow 710, maximum blood flow 712, an optimization speed and sensitivity parameter 714, a urea clearance multiplier 716, a Qb streamline parameter 718, a Qb conventional parameter 720 and a button to edit the dialyzer list 722.

FIG. 8 shows an exemplary dialysis clinical and cost optimization user interface screen in accordance with the present disclosure. The optimization screen 800 includes a user interface element for entering a patient name/identification value 802, and a button to select a dialyzer currently being used 804. The optimization screen 800 also includes user interface elements for displaying and/or editing the following values: dialysate flow 806, treatment time (e.g., in minutes) 808, arterial pressure 810, blood flow 812, urea clearance 814, body water 816, current Kt/V value 818, number of dialyzer uses 820, and desired Kt/V value 822. The optimization screen 800 also includes a checkbox for retaining treatment time for use in the optimization 824 and a checkbox for displaying all solutions 826. The optimization screen 800 also includes a button for solving for Kt/V 828.

In operation, a user or physician can enter a patient's name or other identifier in the “Patient” edit box. The system can recall the patient's existing treatment plan if available. Alternatively, the user can manually enter the current treatment plan parameters. Once the current treatment plan parameters have been entered, the user can enter the number of dialyzer uses and desired Kt/V value and select whether or not to output all solutions. Then, the user can press the “Solve for Kt/V” button and the system will analyze a number of possible treatment scenarios using available dialyzer information (e.g., from those dialyzers with the “Used” checkbox selected) and using the current treatment plan information and desired treatment results to determine one or more treatment plans that may provide improved cost while staying within the constraints and meeting the desired clinical goals.

After the system has completed a treatment optimization function, results can be displayed. FIG. 9 shows an exemplary dialysis clinical and cost optimization user interface screen in accordance with the present disclosure with a result displayed. In addition to the elements of FIG. 8 described above, FIG. 9 shows user interface elements for displaying values for a selected treatment/optimization scenario including: new dialyzer name 902 and predicted values for dialysate flow 904, treatment time (e.g., in minutes) 906, arterial pressure 908, blood flow 910, urea clearance 912, body water 914, and Kt/V value 916. In addition to the clinical parameters for the new scenario, there are cost values displayed including additional dialyzer cost 918, additional cost of new dialysate flow 920, additional cost of new treatment time 922, a total additional cost 924 and an annual additional cost 926.

As can be seen in FIG. 9, the new dialyzer results in an annual savings of $224.90, while meeting clinical constraints and desired Kt/V.

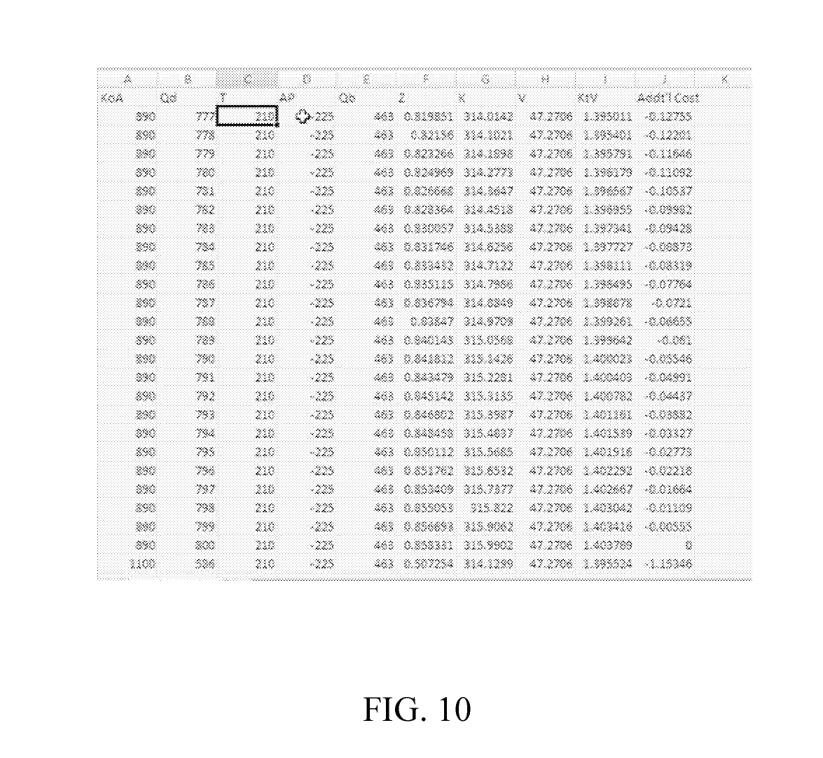

When the “Output all solutions” checkbox is checked, as shown in FIG. 9, a list of all results can be outputted or displayed. FIG. 10 shows an exemplary output including multiple scenarios for clinical and cost optimization.

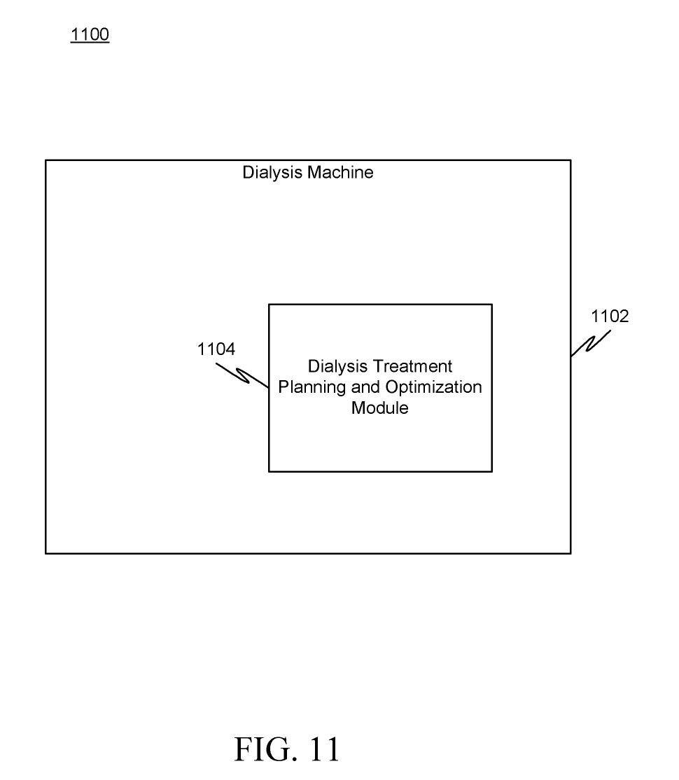

FIG. 11 shows an exemplary dialysis clinical and cost optimization system embedded within a dialysis machine. In particular, a dialysis system 1100 includes a dialysis machine 1102 and an embedded dialysis clinical and cost optimization module 1104.

In operation, the embedded dialysis clinical and cost optimization module 1104 can provide dialysis treatment planning and optimization for patients being administered a dialysis treatment using the dialysis machine 1102. Also, the embedded dialysis clinical and cost optimization module 1104 can be adapted and programmed to automatically adjust treatment parameters in the dialysis machine 1102. These automatic adjustments can be enabled or disabled by a user or a health care provider. Also, the automatic adjustments can be limited such that a parameter can only be changed to a value within a given range specified by a physician or health care provider.

The embedded dialysis clinical and cost optimization module 1104 can include a user interface having user interface controls, such as “slider bars”, to adjust treatment parameters and patient preferences. Software, stored within the embedded dialysis clinical and cost optimization module 1104 can collect and store data regarding patient preferences and treatment parameter settings. The software can use machine learning or collaborative filtering techniques to determine a “template” of predetermined settings that best fit the patient needs such as time available for treatment, etc.

Embedded dialysis clinical and cost optimization module can be adapted to transmit patient preference and parameter settings to another system which can collect the data from multiple embedded dialysis clinical and cost optimization systems. This data can reflect customization (e.g., active setting of parameters) and personalization (e.g., passive parameters or preferences). This data can be used to predict an optimal setting for each patient. The patient or health care provider can be given an opportunity to review the prediction of treatment parameters and preferences recommended by the system and decide whether to accept the predicted parameters.

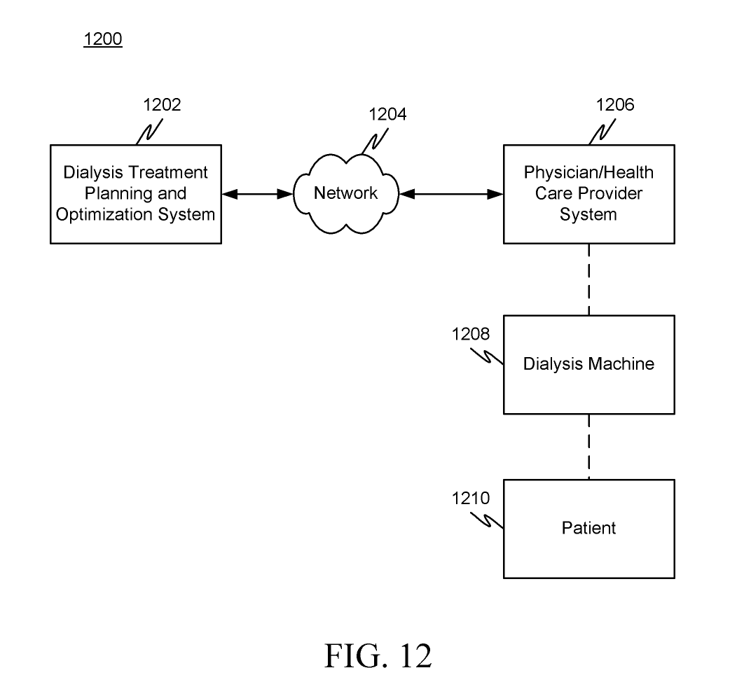

FIG. 12 shows an exemplary dialysis clinical and cost optimization system adapted to provide optimization information via a network. In particular, a system 1200 includes a dialysis treatment planning and optimization system 1202 coupled to a network 1204, which is coupled to a physician/health care provider system 1206. A dialysis machine 1208 (optionally coupled to the physician/health care provider system 1206) can provide dialysis treatment to a patient 1210 according to the optimized dialysis treatment plan provided by the dialysis treatment planning and optimization system 1202.

In the “online” embodiment shown in FIG. 12, the dialysis treatment planning and optimization system 1202 can be accessed remotely (e.g., over the Internet) and provide dialysis planning and optimization services to remote users via the network 1204. The dialysis treatment planning and optimization system 1202 can be used to provide consultative dialysis treatment planning and optimization to users on a fee-basis such as pay-per-use, a subscription plan, or the like.

The dialysis treatment planning and optimization system 1202 can be updated to include new dialyzers and also be updated to reflect changes in patient prescription or needs. Also, the dialysis treatment planning and optimization system 1202 can include automatic tracking of user inputted data & optimizations to create “suggestions” & “trends” for users. These suggestions and trends may help a health care provider or patient plan and optimize dialysis treatment so as to reduce cost, reduce length of treatment time, provide better treatment, or a combination of the above.

The dialysis treatment planning and optimization system 1202 can include a registry of dialyzers that can be modified by users to include dialyzers not listed and to adjust parameters of particular dialyzers to suit the conditions of the user. The dialyzer registry may be analyzed to determine if changes inputted by a user should be made available to other users. For example, if a user adds a new type of dialyzer, information about the new dialyzer could be made available to other users a possible dialyzer choice for treatment optimization.

While embodiments have been described in terms of planning and optimizing hemodialysis, it will be appreciated that an embodiment can be adapted for planning and optimizing peritoneal dialysis, hemofiltration, intestinal dialysis, or the like. In general, any medical treatment that includes parameters or expendable items may be optimized according to an embodiment. Various treatment parameters specific to each type of treatment may be optimized. For example, in a peritoneal dialysis embodiment, there may be no dialyzer to optimize for, but other costs can be optimized, such as amount of fluid and/or length of treatment.

Embodiments of the method, system and computer program product (i.e., software instructions stored on a computer readable medium) for dialysis treatment planning and optimization, may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions or steps described herein can be used to implement embodiments of the method, system, or computer program product for dialysis treatment planning and optimization.

Furthermore, embodiments of the disclosed method, system, and computer program product for dialysis treatment planning and optimization may be readily implemented, fully or partially, in software using, for example, object or object-oriented software development environments that provide portable source code that can be used on a variety of computer platforms. Alternatively, embodiments of the disclosed method, system, and computer program product for dialysis treatment planning and optimization can be implemented partially or fully in hardware using, for example, standard logic circuits or a VLSI design. Other hardware or software can be used to implement embodiments depending on the speed and/or efficiency requirements of the systems, the particular function, and/or a particular software or hardware system, microprocessor, or microcomputer system being utilized. Embodiments of the method, system, and computer program product for dialysis treatment planning and optimization can be implemented in hardware and/or software using any known or later developed systems or structures, devices and/or software by those of ordinary skill in the applicable art from the functional description provided herein and with a general basic knowledge of the computer and/or dialysis treatment arts.

Moreover, embodiments of the disclosed method, system, and computer program product for dialysis treatment planning and optimization can be implemented in software executed on a programmed general-purpose computer, a special purpose computer, a microprocessor, or the like. Also, the dialysis treatment planning and optimization systems and methods can be implemented as a program embedded on a personal computer such as a JAVA® or CGI script, as a resource residing on a server or graphics workstation, as a routine embedded in a dedicated processing system, or the like. The methods and systems can also be implemented by physically incorporating the methods for dialysis treatment planning and optimization into a software and/or hardware system, for example a dialysis machine, a patient information system, or the like.

It is, therefore, apparent that there is provided in accordance with the present invention, a method, system, and computer program product for dialysis treatment planning and optimization. While this invention has been described in conjunction with a number of embodiments, it is evident that many alternatives, modifications and variations would be or are apparent to those of ordinary skill in the applicable arts. Accordingly, applicant intends to embrace all such alternatives, modifications, equivalents and variations that are within the spirit and scope of this invention.

What is claimed is:

1. A method for automatically determining a cost impact of changing a dialysis treatment parameter, the method comprising:
receiving, at a processor, a plurality of dialysis treatment parameter sets, each set corresponding to one of a plurality of patients and each having one or more dialysis treatment parameters;
retrieving, from an electronic data storage device, a predetermined list of dialyzers and corresponding cost and performance data for each respective dialyzer in the predetermined list of dialyzers;
iteratively calculating in the processor, for each patient, a cost impact of at least one scenario in which one or more of the dialysis treatment parameters in the dialysis treatment parameter set for that patient have been changed, the cost impact being determined based both on a clinical impact of changing the one or more dialysis treatment parameters and on a cost value of changing the one or more dialysis treatment parameters including changing a dialyzer for the scenario to one of the dialyzers selected from the predetermined list of dialyzers;
storing each scenario, including the dialysis treatment parameters and the calculated cost impact for each scenario, in the electronic data storage device so as to make each cost impact calculation available for output by the processor;
selecting, using the processor, the scenario for each patient having the most desirable cost impact; and
outputting each selected scenario including the cost impact and the dialysis treatment parameters for each selected scenario.

2. The method of claim 1, wherein the one or more dialysis treatment parameters includes a clinical parameter.

3. The method of claim 3, wherein the clinical parameter is one of an arterial pressure, a bloodline type, a desired Kt/V value, and a treatment time.

4. The method of claim 1, wherein the one or more dialysis treatment parameters includes a specific dialyzer make and model selected from the predetermined list of dialyzers.

5. The method of claim 1, wherein the method is adapted for operation on a personal computer (PC).

6. The method of claim 1, wherein the method is adapted to be provided as a web service.

7. The method of claim 1, wherein the method is adapted for operation on a portable computer.

8. The method of claim 1, wherein the dialysis treatment parameter set includes one or more of a minimum blood flow, a maximum blood flow, a minimum dialysate flow, a maximum dialysate flow, a minimum treatment time, a maximum treatment time, and an optimization speed and sensitivity parameter.

9. The method of claim 8, wherein the iteratively calculating includes changing a value for dialysate flow to a value between the minimum dialysate flow and the maximum dialysate flow, inclusively, in an increment based on the optimization speed and sensitivity parameter.

10. The method of claim 8, wherein the iteratively calculating includes changing a value for blood flow to a value between the minimum blood flow and the maximum blood flow, inclusively, in an increment based on the optimization speed and sensitivity parameter.

11. The method of claim 8, wherein the iteratively calculating includes changing a value for treatment time to a value between the minimum treatment time and the maximum treatment time, inclusively, in an increment based on the optimization speed and sensitivity parameter.

12. The method of claim 1, wherein the cost impact for each scenario is calculated based on cost inputs provided by a user.

13. The method of claim 12, wherein the cost inputs include at least one of an average dialysate cost, a labor cost for each treatment, and an average length of time for each treatment.

14. The method of claim 1, wherein the cost impact for each scenario is calculated based on one or more cost constraints

15. The method of claim 14, wherein the one or more cost constraints include at least one of an average dialysate cost and an average labor cost for each treatment.

16. The method of claim 1, wherein the cost impact for each scenario is calculated based on one or more kinetic parameters that can be modified by a user.

17. The method of claim 1, wherein the outputting includes displaying each selected scenario on a display device coupled to the processor.

18. The method of claim 1, wherein the outputting includes printing each selected scenario on a printer coupled to the processor.

19. The method of claim 1, wherein the outputting includes communicating each selected scenario in an electronic message over a communications network to another system.

20. A system for dialysis treatment planning and optimization, the system comprising:
a processor coupled to a computer readable storage device, the storage device having stored thereon program instructions that, when executed by the processor, cause the processor to perform operations including:
receiving, at the processor, a dialysis treatment parameter set corresponding to a patient and having one or more dialysis treatment parameters;
retrieving, from the storage device, a predetermined list of dialyzers and corresponding cost and performance data for each respective dialyzer in the predetermined list of dialyzers;
iteratively calculating a cost impact of at least one scenario in which one or more of the dialysis treatment parameters in the dialysis treatment parameter set has been changed, the cost impact being determined based both on a clinical impact of changing the one or more dialysis treatment parameters and on a cost value of changing the one or more dialysis treatment parameters including changing a dialyzer for the scenario to one of the dialyzers selected from the predetermined list of dialyzers;
storing each scenario, including the dialysis treatment parameters and the calculated cost impact for each scenario, in the electronic data storage device so as to make each cost impact calculation available for output by the processor;
selecting, using the processor, the scenario having the most desirable cost impact; and
outputting the selected scenario including the cost impact and the dialysis treatment parameters for the selected scenario.

21. The system of claim 20, wherein the one or more dialysis treatment parameters includes a clinical parameter.

22. The system of claim 21, wherein the clinical parameter is one of an arterial pressure, a bloodline type, a desired Kt/V value, and a treatment time.

23. The system of claim 20, wherein the one or more dialysis treatment parameters includes a specific dialyzer make and model selected from the predetermined list of dialyzers.

24. The system of claim 20, wherein the processor is disposed on a personal computer (PC).

25. The system of claim 20, wherein the processor is adapted to operate as a server and provide a web service for dialysis treatment planning and optimization.

26. The system of claim 20, wherein the processor is adapted for operation on a portable computer and the processor and the memory are disposed in a portable computer system.

27. The system of claim 20, wherein the dialysis treatment parameter set includes one or more of a minimum blood flow, a maximum blood flow, a minimum dialysate flow, a maximum dialysate flow, a minimum treatment time, a maximum treatment time, and an optimization speed and sensitivity parameter.

28. The system of claim 27, wherein the iteratively calculating includes changing a value for dialysate flow to a value between the minimum dialysate flow and the maximum dialysate flow, inclusively, in an increment based on the optimization speed and sensitivity parameter.

29. The system of claim 27, wherein the iteratively calculating includes changing a value for blood flow to a value between the minimum blood flow and the maximum blood flow, inclusively, in an increment based on the optimization speed and sensitivity parameter.

30. The system of claim 27, wherein the iteratively calculating includes changing a value for treatment time to a value between the minimum treatment time and the maximum treatment time, inclusively, in an increment based on the optimization speed and sensitivity parameter.

31. The system of claim 20, wherein the cost impact for each scenario is calculated based on cost inputs provided by a user.

32. The system of claim 31, wherein the cost inputs include at least one of an average dialysate cost, a labor cost for each treatment, and an average length of time for each treatment.

33. The system of claim 20, wherein the cost impact for each scenario is calculated based on one or more cost constraints

34. The system of claim 33, wherein the one or more cost constraints include at least one of an average dialysate cost and an average labor cost for each treatment.

35. The system of claim 20, wherein the cost impact for each scenario is calculated based on one or more kinetic parameters that can be modified by a user.

36. The system of claim 20, wherein the system further includes a display device coupled to the processor and the outputting includes displaying the selected scenario on the display device.

37. The system of claim 20, wherein the system further includes a printer coupled to the processor and the outputting includes printing the selected scenario on the printer.

38. The system of claim 20, wherein the system is coupled to a network and the outputting includes communicating the selected scenario in an electronic message over a communications network to another system.

39. A nontransitory computer readable medium having stored thereon program instructions that, when executed by a processor, cause the processor to perform operations comprising:
receiving, at the processor, a dialysis treatment parameter corresponding to a patient;
retrieving, from a storage device coupled to the processor, cost and performance data for a new dialyzer;
iteratively calculating a cost impact of at least one scenario in which the dialysis treatment parameter has been changed, the cost impact being determined based on a cost value of changing the dialysis treatment parameters including changing a dialyzer for the scenario to the new dialyzer;
selecting, using the processor, the scenario having the most desirable cost impact; and
outputting the selected scenario including the cost impact and the dialysis treatment parameters for the selected scenario.

40. The computer readable medium of claim 39, wherein the dialysis treatment parameter is a clinical parameter.

41. The computer readable medium of claim 40, wherein the clinical parameter is one of an arterial pressure, a bloodline type, a desired Kt/V value, and a treatment time.

42. The computer readable medium of claim 39, wherein the dialysis treatment parameter is a specific dialyzer make and model.

43. The computer readable medium of claim 39, wherein the instructions are adapted for execution on a personal computer (PC).

44. The computer readable medium of claim 39, wherein the instructions are adapted for execution on a server and further include providing a web service for dialysis treatment planning and optimization.

45. The computer readable medium of claim 39, wherein the instructions are adapted for execution on a portable computer.

46. The computer readable medium of claim 39, wherein the dialysis treatment parameter includes one of a minimum blood flow, a maximum blood flow, a minimum dialysate flow, a maximum dialysate flow, a minimum treatment time, a maximum treatment time, and an optimization speed and sensitivity parameter.

47. The computer readable medium of claim 46, wherein the iteratively calculating includes changing a value for dialysate flow to a value between the minimum dialysate flow and the maximum dialysate flow, inclusively, in an increment based on the optimization speed and sensitivity parameter.

48. The computer readable medium of claim 46, wherein the iteratively calculating includes changing a value for blood flow to a value between the minimum blood flow and the maximum blood flow, inclusively, in an increment based on the optimization speed and sensitivity parameter.

49. The computer readable medium of claim 46, wherein the iteratively calculating includes changing a value for treatment time to a value between the minimum treatment time and the maximum treatment time, inclusively, in an increment based on the optimization speed and sensitivity parameter.

50. The computer readable medium of claim 39, wherein the cost impact for each scenario is calculated based on cost inputs provided by a user.

51. The computer readable medium of claim 50, wherein the cost inputs include at least one of an average dialysate cost, a labor cost for each treatment, and an average length of time for each treatment.

52. The computer readable medium of claim 39, wherein the cost impact for each scenario is calculated based on one or more cost constraints

53. The computer readable medium of claim 52, wherein the one or more cost constraints include at least one of an average dialysate cost and an average labor cost for each treatment.

54. The computer readable medium of claim 39, wherein the cost impact for each scenario is calculated based on one or more kinetic parameters that can be modified by a user.

55. The computer readable medium of claim 39, wherein the operations further include displaying the selected scenario on a display device.

56. The computer readable medium of claim 39, wherein the operations further include printing the selected scenario on a printer.

57. The computer readable medium of claim 39, wherein the operations further include communicating the selected scenario in an electronic message over a communications network to another system.

58. The system of claim 20, wherein the system is adapted to be embedded in a dialysis machine and to provide dialysis treatment planning and optimization from within that dialysis machine.

59. The system of claim 20, wherein the system is adapted to provide dialysis treatment and planning over a network to a remote user.
